(19) United States
(12) Patent Application Publication
(10) Pub. No.: US 2011/0102197 A1
(43) Pub. Date: May 5, 2011

(54) AUTOMATED PARKING GUIDANCE AND MANAGEMENT SYSTEM

(75) Inventor: Ingo Herwich, Brunn am Gebirge (AT)

(73) Assignee: SOFTWARE SYSTEM SOLUTIONS FC-LLC, Dubai (AE)

(21) Appl. No.: 12/934,925

(22) PCT Filed: Mar. 26, 2009
(86) PCT No.: PCT/AT2009/000122

§ 371 Date: Dec. 22, 2010

(30) Foreign Application Priority Data
Mar. 26, 2008 (EP) 08450042.0
Jan. 8, 2009 (EP) 09450004.8

(51) Int. Cl. G08G 1/14

(52) U.S. Cl. 340/932.2

(57) ABSTRACT

A signalling means (1) for indicating whether a parking place (34) for a vehicle is available or occupied, wherein the signalling means (1) comprises a housing (2) and at least one LED (3) arranged within said housing (2), wherein the housing (2) comprises a cover (4) that is at least partially made of a light-permeable material for constituting at least one light-passage (8) for light emitted by the at least one LED (3), wherein an outer surface of the light passage (8) is slanted towards a bottom portion (9) of the housing (2), and wherein the signalling means (1) further comprises at least one convex-lens (10) that is arranged between the at least one LED (3) and the light passage (8) of the housing (2).

### FIELD OF THE INVENTION

The invention relates to a signalling means for indicating whether a parking place for a vehicle is available or occupied.

The invention further relates to an automated parking guidance and management system.

### BACKGROUND OF THE INVENTION

A signalling means as mentioned in the first paragraph is known from document WO 02/36887 A1. This document shows a signalling means particularly for roads. The construction disclosed in this document comprises a socket, a domed lens mounted on the socket and reflective means mounted in the socket, the domed lens being of a material able to refract reflected light, to allow it to be seen by drivers of oncoming vehicles. With the known signalling means, unfortunately, it has emerged that the intensity of light emitted in a direction of oncoming traffic is not very high. This is why the signalling means can not be seen very well by a driver. A further disadvantage of this embodiment is that due to the reflective means its overall height is increased as well.

An automated parking system as mentioned in the second paragraph is known from document WO 02/063570. This document shows a system including one or more wireless vehicle detectors, which are connected with a distributed parking payment system such as parking meters or a pay-station. Information from the payment system and the vehicle detectors may be combined to determine when a parking violation occurs, or is about to occur. This information may then be transmitted through a communication system to a parking enforcement officer, along with information about the geographic location of the violation. The information may also, or instead be transmitted to a parking payer to notify the payer of an impending infraction so that the payer may purchase additional parking time before the violation. This system further comprises a display unit, which may be, for example, an LED display. The LED-Display may receive text or other data from a central computer for display. This may include, for example, a visual indication of the availability of parking spaces. It is a disadvantage of the embodiment known from WO 02/063570 not suitable to indicate a free parking place in situ providing a good visibility for a driver passing by. A further disadvantage of the parking management system shown in WO 02/063570 is that due to the use of wireless-sensors the maintenance effort is rather high, since batteries of the sensors have to be recharged periodically.

### SUMMARY OF THE INVENTION

It is an object of the invention to provide a signalling means of the type mentioned in the first paragraph and a parking management system of the type defined in the second paragraph, in which the disadvantages defined above are avoided.

To achieve the object described above, characteristic features according to the invention are provided with a signalling means according to the invention, so that a signalling means according to the invention can be characterized as follows:

A signalling means for indicating whether a parking place for a vehicle is available or occupied, wherein the signalling means comprises a housing and at least one LED arranged within said housing, wherein the housing comprises a cover that is at least partially made of a light-permeable material for constituting at least one light-passage for light emitted by the at least one LED, wherein an outer surface of the light passage is slanted towards a bottom portion of the housing, and wherein the signalling means further comprises at least one convex-lens that is arranged between the at least one LED and the light passage of the housing.

The characteristic features according to the invention provide the advantage that the visibility of the signaling means is enhanced due to the arrangement of a convex lens inside the housing. Furthermore the overall height of the signaling means can be reduced since there is no need for reflecting means according to the invention. Due to its low construction the signaling means according to the invention can easily be integrated into a hump or another constructional element without forming any protruding edges.

According to a preferred embodiment of the invention the signalling means can comprise at least two LEDs of different colours housed by said housing, wherein the signalling means is arranged to emit light of different colours according to the availability status of the parking place. Preferably at least one of the at least two LEDs is arranged within the focal plane of the at least one convex lens. In other words light emitting sections of the LEDs may be arranged within the focal plane of the convex lens. By means of this measure an essentially coherent light beam can be achieved before the light leaves the housing through the light passage. For the purpose of deflecting light generated by the at least one LED in the direction of oncoming vehicles at least one deflecting prism is arranged inside the housing and between the at least one convex lens and the light passage. Alternatively the light passage itself may form a deflecting prism itself for deflecting light generated by the at least one LED in the direction of oncoming vehicles. By means of the measures mentioned in this paragraph the advantage is achieved that the light emitted by the LEDs and concentrated by the lens can be directed into a desired direction to further enhance the visibility of the signaling means.

However, it has proved to be particularly advantageous if the housing comprises a cylindrical base portion that is covered by the above mentioned cover and a ring shaped cover portion comprising a ring-shaped flange extending in a radial direction from the base portion. This achieves the advantage of a compact shape and an improved handling during assembling the signaling means. By means of the ring-shaped flange a good connectivity with another mounting element such as an adapter can be achieved. Furthermore mounting the signalling means directly into the ground is facilitated as well.

It is of further advantage if the signalling means comprises an adapter for mounting the signalling means onto a hump forming a cable duct, wherein the adapter comprises a recess for inserting the housing, wherein the ring shaped flange and an inner edging of the recess adjoin to one another continuously. This achieves the advantage that the signaling means can be integrated in the hump defining the parking place's. Due to the technical features of this embodiment the signaling means are protected against damage in a very efficient manner.

If the adapter comprises an outwardly slanted edging area, it is possible to further improve the signalling means with regard to the use of street-cleaning devices. Due to the slanted edging area of the adapter it is possible to drive over the signalling means with a snow-plough, with a vehicle for street-cleaning comprising brushes etc. without damaging the signalling means.

A high operational reliability of detecting parking vehicles ensuring independency of effects of the weather can be achieved by that the signalling means comprises at least one earth-magnetic-field-sensor for detecting the presence of a parked vehicle in the single parking place, wherein the earth-magnetic-field-sensor is arranged within the housing.

To display whether the parking place is available or not it is of advantage that the signalling means comprises a control unit connected to the at least one earth-magnetic-field-sensor and to the at least two LEDs, wherein the control unit activates one of the at least two LEDs according to a signal generated by the sensor to indicate the status of availability of the respective parking place.

To enable the implementation of a billing-system the signalling means may comprise an RFID-reader that is arranged within the housing.

Furthermore the signalling means may comprise a camera module for taking pictures of the parking place, wherein said camera module is located within the housing.

In order to achieve the object defined above, with a system according to the invention characteristic features are provided so that a system according to the invention can be characterized in the way defined below, that is:

An automated parking guidance and management system, wherein a signalling means as claimed in one of the claims 1 to 7 is mounted at the front end of a parking place, wherein the parking place has to be entered by a vehicle via the front end. Due to the arrangement of signalling means at the front end of the parking place a very good visibility of the signalling means is achieved.

According to an embodiment of the invention the signalling means is mounted on a hump forming a cable duct for power supply lines for the signalling means, wherein the hump is mounted at the front end of the parking place for a vehicle and the vehicle has to drive over the hump for entering the parking place.

Furthermore the parking management system may comprise an RFID-reader that is located inside the signalling means, which RFID-reader is arranged to detect the presence of an RFID-tag within a predetermined area, wherein the system is arranged to check using identification information received from the RFID-tag whether the RFID-tag is valid and thus the owner is allowed to use the parking place. The parking management system can be arranged to bill and the parking place automatically using the information received from the RFID-tag. Furthermore the parking management system can be arranged to indicate by means of the colour of light emitted by the signalling means if the utilization fee for the parking place is not paid, e.g. if the RFID-tag is not valid any more.

The aspects defined above and further aspects of the invention are apparent from the examples of embodiment to be described hereinafter and are explained with reference to these examples of embodiment.

### BRIEF DESCRIPTION OF THE DRAWINGS

In the following, the present invention is described in more detail with reference to the drawings in which:

FIG. 1 is an explosive view of signalling means according to the invention;

FIG. 2 is a lateral view of the signaling means of FIG. 1;

FIG. 3 is a schematic cross-sectional view of the signaling means of FIG. 1, indicating the light-path through the lens and the light passage;

FIG. 4 is a top view of the signaling means of FIG. 1;

FIG. 5 is a block-diagram of the signalling means of FIG. 1.

FIG. 6 is a perspective view of an hump forming a cable duct and an adapter for mounting the signaling means on said hump;

FIG. 7 is an explosive view of the signaling means of FIG. 1 and the adapter of FIG. 5;

FIG. 8 is a lateral view of the signaling means and the adapter of FIG. 6;

FIG. 9 is a lateral view of the signaling means and the adapter in an assembled state;

FIG. 10 is a top view of the signaling means and the adapter of FIG. 8 mounted on a hump;

FIG. 11 is a perspective view of a parking place with a signalling means of FIG. 1 mounted on the front end of said parking place.

FIG. 12 is a perspective view of a parking place with the hump and signalling means of FIG. 9 mounted on the front edge of said parking place;

FIG. 13 is a block-diagram of a parking management system according to the invention.

FIG. 14 is a first screenshot of a parking inspector's handheld computer.

FIG. 15 is a second screenshot of the handheld computer of FIG. 14.

FIG. 16 is a third screenshot of the handheld computer of FIG. 14.

The figures are schematically drawn and not true to scale, and the identical reference numerals in different figures refer to corresponding elements. It will be clear for those skilled in the art that alternative but equivalent embodiments of the invention are possible without deviating from the true inventive concept, and that the scope of the invention will be limited by the claims only.

### DETAILED DESCRIPTION OF THE INVENTION

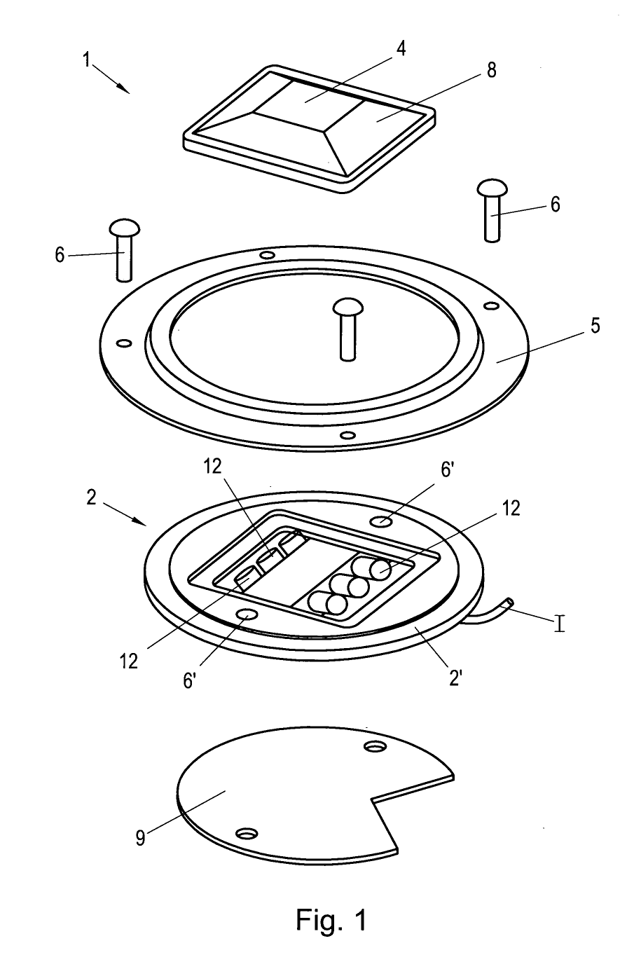

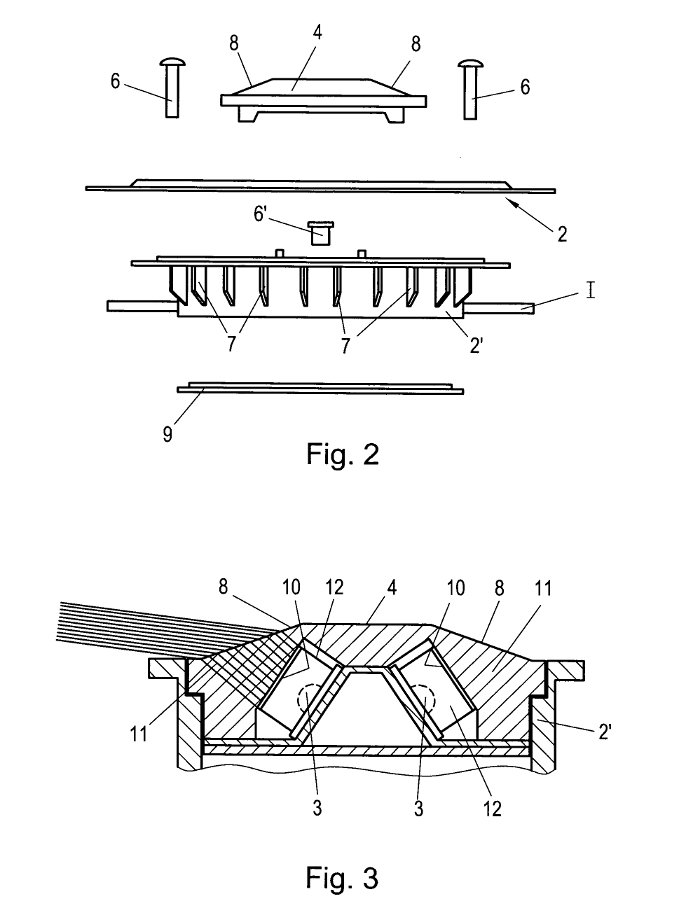

FIGS. 1 and 2 show a signalling means 1 according to the invention. The signalling means 1 is used for indicating whether a single parking place for a vehicle is available or occupied. In this document “parking place” means a defined parking area for a single vehicle e.g. a parking slot limited by lateral markings. Further the invention is preferably used for outdoor parking places. But nevertheless, the invention can be used for indoor parking places as well.

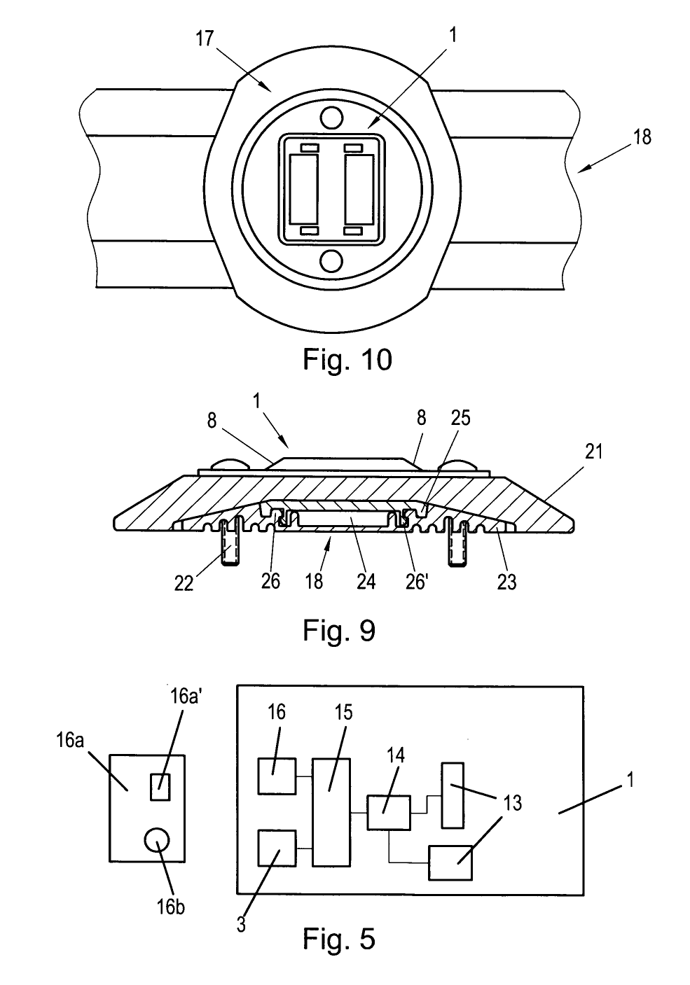

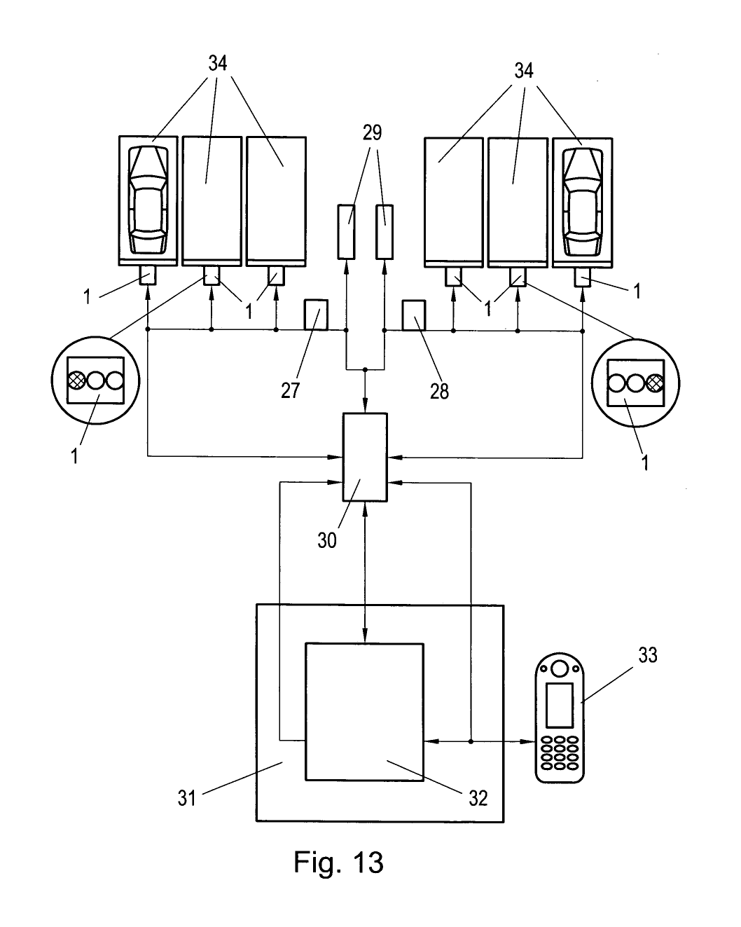

The signalling means 1 comprises a housing 2 and at least one LED arranged within the housing 2. The LED is indicated with the reference sign 3 in FIG. 3. In case of just one LED 3 the LED 3 can be activated by a control unit of the signalling means 1 in case the parking space is available. The control unit may be a CPU, a micro-processor or signal-processor respectively. The control unit mentioned in the last sentence is indicated with the reference sign 15 in FIG. 5. It shall be mentioned that the activation of the LEDs 3 can be done by means of a control unit external to the signalling means. The external control unit can be a server as illustrated in FIG. 13.

Preferably the signalling means 1 comprise two or more LEDs 3 of different colours. For indicating if a parking place is available or occupied the signalling means 1 may be arranged to emit light of different colours according to the availability status of the parking place. At this point it shall be mentioned that in the present context the term “light” means visible light.

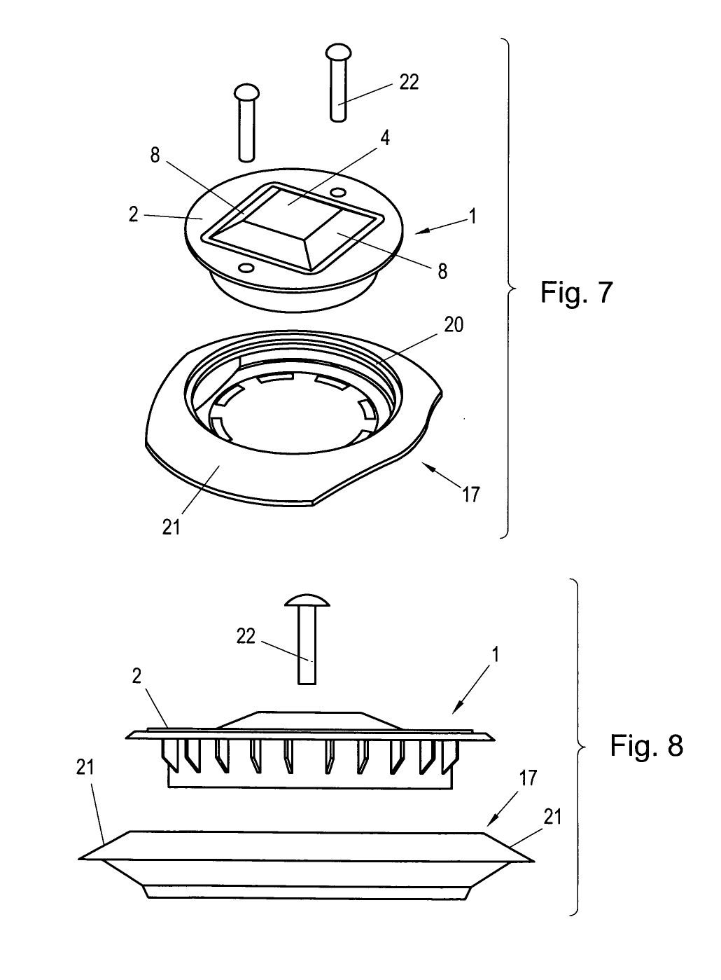

The housing 2 comprises a cylindrical base portion 2′. The base portion 2′ is covered by the cover-portion 4. The housing 2 further comprises a ring-shaped flange 5 extending from the base portion 3 in a radial direction. The housing 2 may be hold together by means of screws or bolts 6′ respectively. Further the signalling means 1 can comprise bolts 6 for mounting the signalling means 1 to the ground or onto another assembling element such as a hump. Space holders 7 can be arranged on the outer circumferential surface of the base portion 3 for ensuring a correct fit of the housing 2 inside an adapter, indicated with the reference sign 17 in FIGS. 6-9. The cover-portion 4 comprises one or more light-passages 8 made of a light-permeable material. By means of the light passages 8 light generated by one or more of the LEDs 3 can be emitted to the outside of the signalling means 1. An outer surface of the light passages 8 is outwardly slanted towards the bottom portion 9 of the housing 2 or towards a plane containing the bottom portion 9 respectively. By means of the features mentioned in the last sentence the advantage is achieved that the light generated by the LEDs 3 can be emitted towards oncoming vehicles.

The signalling means 1 further comprises at least one convex-lens 10 that is arranged between one or more LEDs 3 and the light passage 5 of the housing 2. Preferably there are more lenses 10 arranged side by side in the housing 2. According to a first embodiment of the invention there may be one lens 10 for each LED 3, wherein the LEDs 3 each can be arranged in the focus of the respective lenses 10. Alternatively more LEDs 3 of the same colour could be assigned to one lens 10 as well. In the latter case the LEDs 3 assigned to the same lens 10 are preferably arranged within the focal-plane of the respective lenses 10. By arranging the LEDs 3 in the focus or the focal plane of the respective lenses 10 an essentially coherent beam of light can be achieved, as it is illustrated in FIG. 3. After having passed the lens 10 the light emitted by the LED 3 passes the light passage 8.

To deflect the LED-generated light in a desired direction the light passage 8 may comprise a wedge shaped cross-section to form a prism 11. Of course the light passage 8 may comprise a different cross-section forming another kind of deflecting prism 11 as well. Alternatively a suitable deflecting prism 11 may be arranged inside the housing 2 between the lens or lenses 10 respectively and the light passage 8 as well. Those skilled in the art know many prisms to achieve the distribution of emitted light as shown in FIG. 3. By means of the deflecting prism 11 the light beam may be deflected into a desired direction. The measures mentioned in this paragraph increase the visibility of the signalling means 1 very efficiently. Since the angle of beam spread of the emitted light is rather narrow, the light-intensity emitted towards on-coming vehicles is increased.

According to FIGS. 1, 3 and 4 each single LED 3 may be arranged in cylindrical socket 12 that is covered by the convex lens 10. Alternatively more than one LED 3 may be arrange in a socket 12 as well.

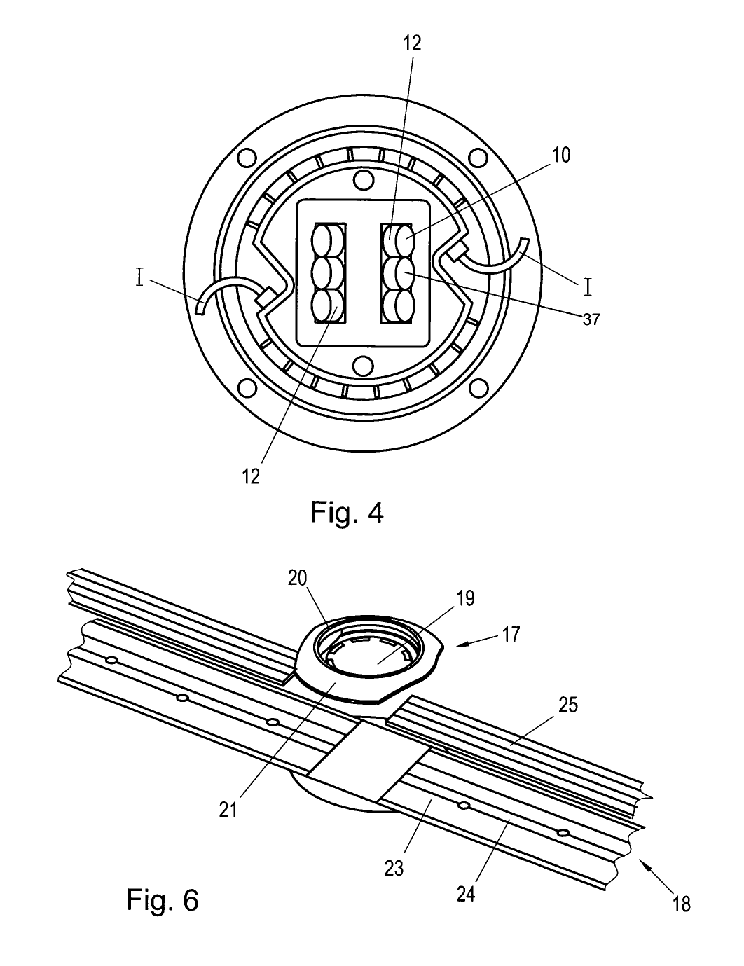

As illustrated in FIGS. 3 and 4 there are six sockets 7 which are arranged in pairs along a middle plane of the cover 3. This arrangement provides the advantage of a good visibility in both directions of traffic. Preferably each socket 12 comprises LEDs 3 of the same colour, e.g. one of the sockets 12 may comprise red LEDs for indicating that the parking place is occupied by a vehicle, another one of the sockets 12 may comprise green LEDs for indicating that the parking place is available. Still another socket 12 may comprise amber LEDs for indicating another status of the parking place, e.g. for indicating if a driver of a parked vehicle has not paid for using the parking place and thus is not allowed to use it.

Summarizing it can be said that according to a preferred embodiment of the invention built-in high-quality LEDs 3 (e.g. up to 20,000 mcd) show different colours for different states of the parking place (e.g. green=vacant, red=occupied, amber=not paid, blue=vacant disabled parking space) and enable drivers to easily and quickly find a free parking space even in daylight conditions. LEDs can also be used to indicate parking vehicles which have exceeded their parking credits. In-built photo sensors may be used to guarantee that the LED brightness is always adapted to the ambient light to provide optimal visibility.

As shown in FIG. 5 the signalling means 1 further comprises one or more earth-magnetic-field-sensor 13 for detecting the presence of a parked vehicle in the parking place. Vehicles contain ferrous materials that disturb the uniform intensity and direction of the earth's magnetic field. The magnetic field sensor 13 takes advantage of this natural phenomenon and detects the presence and position of cars. A combination of 2 multi-axis magnetic field sensors 13 offer the highest magnetic field sensitivity for applications requiring the most discrimination (e.g. in multi-level car parks). The sensors 13 can be connected to an analog/digital-amplifier 14. The amplifier 14 itself can be connected to the control-unit 15 of the signalling means 1.

Magnetic field sensors are maintenance-free, free of wear and tear, have low power consumption and are resistant to any weather. The magnetic-field-sensors are integrated in the housing of the signalling means as well. Furthermore an RFID-reader is arranged within the housing of the signalling means.

According to an embodiment of the invention the control unit 15 can be connected to the earth-magnetic-field-sensors 13 and to the LEDs 3, wherein the control unit 15 activates the LEDs 3 according to a signal generated by the sensor 13 and amplified by the amplifier 14 to indicate the status of the respective parking place. Alternatively the control unit 15 can be connected to an output of an RFID-reader 16 as well, wherein the control unit 15 can be arranged to activate the LEDs 3 by using output-signals of the RFID-reader 16 and the magnetic field sensors 15 to indicate the status of the parking place. The control unit 15, the RFID-reader 16, the magnetic-field-sensor 13 and the LEDs 3 are arranged within in the housing 2 of the signalling means 1.

The RFID-reader 16 reads RFID-tags 16a that are around. By synchronism of the magnetic field sensor's 13 car detection and detection of RFID-tag's signal, the assignment of the individual tag to the parking space can be made very efficiently.

According to the preferred embodiment of the invention each parking space is equipped with a signalling means 1 according to the invention holding the built-in components:
Magnetic field sensor 13 for vehicle detection
RFID-reader 16 for parking tag detection and payment purposes
LED space/payment status indicator 3. Extremely powerful, daylight compatible red/green LED and a multicolour high power LED enable best visibility; including automatic dimming to adjust to ambient light conditions.

The (circular) signalling means 1 can be mounted
as a standalone version directly on the street/floor (by drilling a hole into the floor)—also cable ducts must be cut for the wiring from signalling means to signalling means;
on a extrusion molded hump, which acts as the cable duct from signalling means 1 to signalling means 1. The hump indicated with the reference sign 18 in FIG. 6 can be easily screwed or glued to the road.

Signalling means and/or hump can also be equipped with solar panels for additional power supply. In the latter case a battery pack can also included.

According to a further advantageous embodiment of the invention the signalling means 1 may also comprise a camera module 37 for taking pictures of the parking place (FIG. 4). However, the camera module 37 is an optional component of the signalling means 1. The camera module 37 is arranged inside the housing 2 of the signalling means 1 and may be simply plugged in a part of the signalling means 1 carrying the indication LEDs and the lenses 10.

The camera 37 may be equipped with a 120 to 140° lens. This lens makes it possible to capture the complete vehicle front or rear even at little distances (>30 cm) and captures the complete license plate.

The camera may be triggered every time the magnetic field sensor 13 shows a relevant detection pattern according to the firmware settings that suggests that:
1.) A vehicle has entered or left the parking space
2.) Somebody is trying to manipulate the magnetic field sensor (e.g. with a mobile phone or something else), trying to simulate a vehicle entering or leaving the space
3.) A vehicle passing on the main lane very close to the sensor causing a detection pattern similar to that of a vehicle entering or leaving the bay.

The camera 37 can also be triggered in the following events:
1.) The camera 37 is calibrated
2.) An alleged parking offence occurs (vehicle exceeding the permitted parking time, no parking fee paid etc.)
3.) During an individually definable control routine the status of the parking space is checked
4.) The operator in the control room manually triggers the camera 37

In order to reduce possible interferences of the integrated LED and the magnetic field electronics with the picture processing, and to reduce power consumption, parts or whole areas of the electronics may be switched off or to standby during the camera snapshot.

The camera complies with 4 functional focuses:
1.) Improve the basic detection carried out by the magnetic field sensor to increase the detection accuracy to >99%
2.) Prevent manipulation—no matter whether it is intentional or not
3.) For parking payment applications: capturing of a photographic proof of the parking vehicle, including date and time of parking time start, date and time when the paid parking time expires; all pictures showing license plate (as far as this is practicable due to the position of the magnetic field sensor and the vehicle); for assessing and initiating of an administrative procedure in case of parking offences without the necessity to be present on site (from the control room)
4.) To capture the license plate (as far as this is practicable due to the position of the magnetic field sensor 13 and the vehicle) and to transfer the picture data to a license plate processing system to find out which license plate is parking on which parking space (with an interface to a parking space management system equipped with a barrier, the position and bay number of each captured license plate can be displayed on the screen of the operator when the ticket is paid, which makes it easier for the customer to find his or her vehicle)

The camera window is level with the sensor shell, that means the housing 2, and is designed and positioned in a way to be cleaned by the tyres of the vehicles entering or leaving the bay.

The magnetic field sensor 13 or the signalling means 1 respectively can be crossed by street cleaning vehicles and devices, also cleaning the sensor glass. This ensures that the quality of the photos is not impaired by soil, dirt or stain.

The photos may be stored for internal comparison and recognition directly in a respective memory of the signalling means 1.

To find out whether the bay is occupied or free, a respective software, that may be installed in a processing unit located within the signalling means 1 is applied including the following features:
1.) Recognition of contrast values of at least 12 image sectors for the comparison before/after the change in the magnetic field characteristics (see above)
2.) Capturing and comparison of contour and brightness values for the comparison before/after the change in the magnetic field characteristics (see above)
3.) Storing and sending the picture files to parking service application

The parking service application comprises, among others, the following features:
1.) Settings and storage options of picture parameters; applicable to each individual signalling means 1 to provide optimal photo quality under all light conditions
2.) Automatic notification when a camera fails to deliver the expected photo quality parameters (anti-fraud alert)
3.) Optional automatic license plate analysis saving the pictures and the analysis result of the individual parking actions
4.) Data storage and administration for manual checks whether parking regulations are complied with
5.) Data storage and administration for manual verification before an administrative procedure is started
6.) Data storage and administration including picture file for statistical evaluation of parking behaviour, related to individual bays, streets, sections, districts etc.
7.) Data analysis related to license plate number: district or regional codes (if such exist); related to parking tags, parking behaviour (parking times, frequencies, spaces etc.)
8.) Data analysis of payed/consumed parking credits, recharging of parking credits, use of mobile phones or pay-per-space parking machines etc.

FIG. 6 shows an adapter 17 for mounting the signalling means 1 onto a hump 18. The hump 18 constitutes a cable duct for power supply lines and/or data lines for the signalling means 1. The power supply or data lines respectively are indicate with the reference sign I in FIGS. 1, 2 and 4.

The adapter 17 comprises a recess 19 for inserting the housing 2, wherein the ring shaped flange 5 of the housing 2 and the inner edging 20 of the recess 19 adjoin to one another continuously essentially without forming an step. The edging 21 of the adapter 17 is outwardly slanted to minimize the distance between the edging 21 an the surface of the hump 18 in a mounted state. Preferably the shape of the edging 21 is formed to match the shape of the upper surface of the hump 18.

As can be seen in FIGS. 7-9 the adapter 17 and the housing 2 can be fixed to the hump 18 by means of screws or bolts 22.

According to FIGS. 6 and 9 the hump 18 comprises a base portion 23 with a groove 24 and a cover portion 25 for covering the groove 24 after inserting a power supply and/or data line I for the signalling means 1. The base portion 23 and the cover portion 25 of the hump 18 each can comprise corresponding lugs. By means of the lugs 26, 26′ the cover portion 25 can be snapped on the base portion 23. In countries with frequent snowfalls, the signalling means 1 and the humps 18 can be equipped with additional LEDs to melt snow lying on the visible part of the signalling means 1 and on the humps 18.

The humps 18 are available in standard lengths and can be put together to the required length, for example, 2.20 m for diagonal parking spaces and 5 m for parallel parking spaces. The gap between the humps 18 can be bridged via a cover which looks like the humps 18. Alternatively, the hump 18 can end at the centre of the parking space and the signalling means 1 is the connecting link to the next hump 18. The adapter 17 also allows angled mounting so that also parking bays that are not straight lined can also be equipped easily.

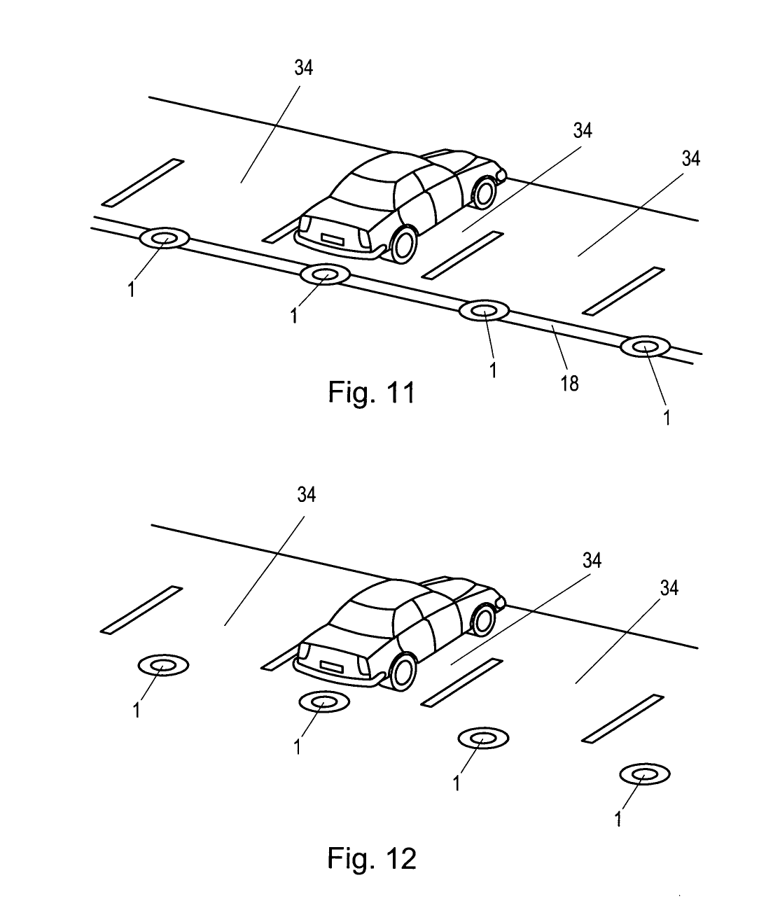

The humps 18 can act as cable ducts through which the wiring from signalling means to signalling means is done (FIG. 11). In case of standalone signalling means, the cable ducts may also be cut into the floor (FIG. 12).

Additional short humps (without signalling means) can be used to define the boundaries of the parking bays.

In any case the hump 18 is marking the front of the parking space—painted markings and their maintenance (repainting) become obsolete.

Furthermore, the middle part of a hump 18 can be replaced by (or delivered with) a strip in various colours to permit parking space labelling (e.g. blue for special needs parking spaces).

The backside of the hump 18 can be equipped with drainage ducts to drain off water.

In order to provide a cost-effective possibility to block or reserve parking spaces, humps 18 can be equipped with a blocking device: when configured to be “reserved” or “blocked”, air is pumped pneumatically into a bag hidden in the hump 18. The bag fills with air and becomes a “stump” that “blocks” the entry of the parking space. Naturally, vehicles and the blocking bag are not damaged when vehicles move over the stump: for this situation the bag can be equipped with a valve. Before the vehicle entitled to occupy the parking space enters it (or when the parking space is configured to be “free” again), the air is sucked out of the bag and the bag hides in the hump 18.

Reservation of a parking place can easily be done by using RFID-tags 16a and RFID-readers 16, wherein each signalling means 1 comprises an RFID-reader 16 that is arranged within the housing 2 of the signalling means 1 as already mentioned above (FIG. 5). The RFID-reader 16 recognizes and identifies individual tags 16a, the reservation function allows parking space reservation of a certain space for a certain vehicle (or rather, a certain tag).

The RFID-tag 16a has to be placed within the car—preferably on the dashboard to support visual control by the parking inspector.

RFID-tags offer two big advantages: They are cheap—much cheaper than microwave, which is mainly used nowadays for reliable road pricing applications. The second advantage is their reliable detection range of up to 6-8 meters.

The tags 16a are available in ISO card format with a thickness of 8 mm. The tags have a bar code for unequivocal tag identification. The bar codes are used for refunding, recharging and identification during the vending process.

The parking operator can transfer the tag costs to the tag holders, recollect them through advertising on the tags 16a, or simply transfer the costs to the parking customers by taking a deposit that can be refunded when the tag will be returned. Handling charges or abrasion charges can be processed by the system operator decision. When the costs of Pay&Display-paper tickets (that are normally thrown away once parking is over) are compared to the HF tag price, the price of the RFID-tag 6a, which can be used for years, is affordable. In addition, the tags are, as an option, refundable at any vending machine or issuing office.

The tag 16a can be powered by a button cell battery that can easily be replaced by the tag holder. It is the tags holder's duty to take care of the tag and battery power. Low power will be indicated by an audible and visible (LED) signal so that the holder gets alerted to change the battery soon. Alternatively the RFID-tags 16a can be a passive tag as well. In the latter case the tag 16a is powered by the electromagnetic field generated by the RFID-reader 16.

If a tag 16a is defective, the tag holder can still pay a parking fee by mobile phone, get a substitute tag at a parking shop or simply buy a new one. Old credits can be transferred to the new tag by the tag holder via the internet, or in parking shops.

The RFID-tags 16a can have an integrated buzzer and/or LED, which deliver audible and visual signals in the following cases:
Tag detected by the RFID-reader 16, parking time started: 3 ascending tones, last tone long, LED green for some seconds.
Connection between RFID-reader 16 and tag 16a stopped: 2 descending tones, second tone long, LED red for some seconds.
Parking credits are running low. If the tag holder has registered for this service, he receives an additional text message on his mobile phone when credits are running low. LED orange for 1 hour.

The integrated RGB-LED can also show the amount of prepaid parking credits—when credits run low, the LED becomes ever more red.

According to FIG. 13 a parking management system 1a according to the invention can comprise one or more junction boxes 27, which are used to power the RFID-reader 16, magnetic-field-sensors 13 and LEDs 3. The junction box 27 can also be used to transmit the collected data via a network, by radio, GPRS, ISM radio or cable to section controllers 28 which may communicate via substations 29 with a main control station 30. The main control station 30 can generate a signal according to the data received to activate the LEDs of the signalling means 1.

Powerful, highly reliable, and redundant data servers may be set up in the parking control centre 31 for the purpose of data processing. These servers are part of the central parking management system (CPMS) 32 and exchange all relevant data fully automatically.

The CPMS 32 can also transfer data to parking inspectors on the streets, who are equipped with Hand Held Computers 33 (HHC, similar to PDAs), with which they can find out which cars have no parking tag 16a or tags 16a with no credit. Also fining procedures and all other functions according to the CPMS 32 and HHC 33 requirements can be carried out with the HHCs 33.

The junction boxes 27 can also contain ISM modules which supply local HHCs 33 with information of close by parking zones. (Navigation to parking spaces is provided to the parking inspectors, however, via GPS).

In the morning, when the parking time window starts (e.g. at 08:00), the tags start the parking time automatically when they get the starting signal from the RFID-reader 16 and charging begins. This procedure increases the parking revenue and is highly convenient for honest people who are willing to pay for parking, since they do not have to go down to their car to start the payment procedure, and saves them costs for the mobile parking payment text message/phone. However, the automatic start function can be deactivated by the tag holder on the Internet, in case that he does not want to use this feature.

In addition, the tags 16a can have a button 16a′ for starting and stopping the parking procedure (FIG. 5). For starting the parking procedure, the customer has to press the button 16a′ e.g. for at least 1 second. For stopping the parking procedure, the customer has to press the button again e.g. for 2 seconds; however the procedure will be stopped automatically when the driver backs up and leaves the detection range of the magnetic field sensor 13. The audible signals tell the customer which action he has taken and what the system did automatically. A 3-colour LED (indicated with the reference number 16b in FIG. 5) of the tag 16a shows the user the state of his tag 16a (green=parking is paid, orange=the parking credits have fallen below a certain limit, red=no credits or defective). However, the parking procedure and signalisation only becomes active when the tag 16a can receive a signal from the receiver 16 integrated in the signalling means 1. Due to the system's processing speed (from the receiver via GPRS/radio to a server of a parking system and back) it will take a couple of seconds to get feedback about the payment status from the system. Hence, the tag holder is advised to wait once he has pressed the button 16a′ and heard the audible signal until he receives payment confirmation by the LED status.

Since the tags 16a emit signals radially, the receiver of the RFID-reader 16 also communicates with tags 16a of cars passing by, moving slowly in traffic jams, or waiting at red traffic lights.

The signalling means 1 can be arranged to distinguish slowly moving vehicles from parking cars via the so-called parking activation time. After this time, the tag 16a of the parking vehicle is read, and its real parking time start (recorded before by the magnetic field sensor) is communicated to the parking system.

The parking activation time gives motorists some time to:
1.) buy a parking tag 16a and activate it in their car;
2.) activate their tag 16a;
3.) recharge an empty prepaid tag 16a (walk to the ATM or an issuing point, recharge via mobile phone etc.).

In addition, the parking activation time helps “suppressing” tags 16a of vehicles or persons (coming from the tag vending machine etc.) that just pass by (by checking whether a tag signal with a continuous signal strength persists).

All tags 16a are detected and read by the system once they approach a receiver 16. This detection is, however, done in the background, and the operator will not receive data until the parking activation time (at least 5 minutes, can be adjusted) is exceeded by a tag with a constant signal strength. Only then will a data record visible to the operator be transmitted to the operation software indicating the tag number and the occupied parking space 34. If no tag 16a is detected after the parking activation time, the system alerts that the parking vehicle has no tag 16a. The real parking time of vehicles is not influenced by the parking activation time since magnetic field sensors 13 of the parking space 34 have recorded the actual parking time start.

There is no way that motorists start parking payment unintentionally, because they have to press the “Start Payment” button 16a′ of the tag 16a. Payment can start automatically only in the morning when vehicles had been parked over the night and parking time subject to payment starts. In this case, however, the system knows about the parking vehicle because the tag receiver 16 and the magnetic field sensor 13 have recorded consistent conditions of the respective space.

Cars that have no parking tag 16a are detected by the signalling means 1, which transmits a signal to the CPMS. The CPMS starts a database query and waits for the (adjustable) parking activation time to give the motorist the chance to buy a tag or start payment via other means (mobile phone, NFC etc.). If the reader 16 does not receive a signal from a prepaid tag 16a within the PAT time window or from the system that the motorist has paid via other means, the CPMS sends an alert to the HHC of the inspector who is nearest to this parking space at that time. The parking inspector receives information on where exactly (street name, exact position) the respective car is parked. The LED 3 of the signalling means 1 can show an amber light, which provides additional information for the motorist that he is actually committing a parking offence and that he has to buy a tag 16a at the next vending machine or in a parking shop or has to pay via other means.

Once he has placed a valid tag 16a within the PAT in his car and the system starts the payment procedure (starting at the time the car was detected by the sensor box!), the motorist is informed about this by the LED 16b of the tag 16a and on the signalling means 1.

System operators can decide on whether they want the signalling means 1 to show via LED 3 that vehicles are parking without payment.

Since it cannot be assured by 100%—by physically given facts—that the RFID-reader of the parking space of the respective RFID-tag 16a placed in the vehicle receives the signal with the higher signal strength than the car tag next to this parking space 34, the HHC has an additional feature to assure that fines are issued to the right car. However, this can only happen, when two cars enter adjacent parking spaces their owners and push the payment start button on the parking tag exactly at the same time.

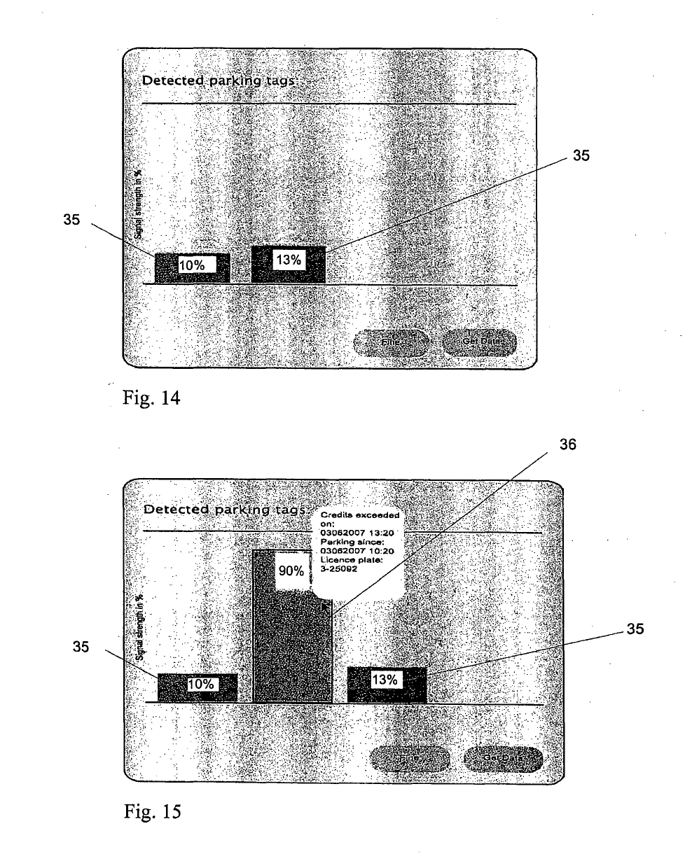

Thus cars that have no parking tag 16a can be detected by parking inspectors through an automatic measuring tool that is integrated in a parking inspector's HHC 33 (PDA) measuring the intensity of the tag signal when the parking inspector approaches the tag 16a that is somewhere in the car. On the parking inspector's HHC, the intensities of the nearest parking tags are shown via signal strength bars 35, 36 (see FIGS. 14-16).

Example: The parking inspector receives a notification on his HHC 33 that a vehicle in Street XY has not paid. He approaches the car whose floor LEDs show “not paid” and positions his HHC 33 near the windscreen (where the parking tags are usually to be placed).
Possibility 1: The car has no parking tag 16a. Thus the HHC 33 shows two or three weak tag signals 35 from the neighbouring cars, but no strong signal from the car in front of which the parking inspector is standing, so he knows that this is the right car. Before he starts the fining procedure he checks the license plate on his HHC 33 whether the parker has paid via mobile phone and he is standing before the wrong car. If the motorist has not paid, then the parking inspector will start the fining process (see FIG. 14).
Possibility 2: The car has an invalid parking tag or no more credits. Thus the HHC 33 shows a very strong signal 36 for this tag 16a indicating that the tag 16a is not valid and the parking inspector can request information from the server on the tag 16a in the respective car (see FIG. 15). Before he starts the fining procedure he checks the license plate on his HHC 33 whether the parker has paid via mobile phone. If he has not, then the parking inspector will start the fining process.

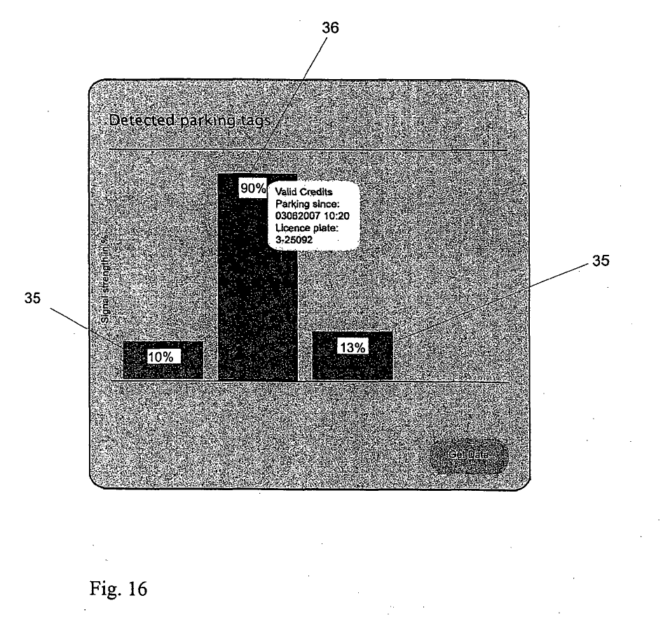

FIG. 16 shows a car with a valid parking tag 16a.

Different colours of the signal strength bar 36 can be used to indicate further information. E.g. if the signal strength bar 36 of the tag 16a is for example yellow, the car holder is a resident of a different zone of the city (for which he has a monthly or annual parking permit). The yellow colour indicates that he is now charged via the prepaid parking credits of his tag 16a.

HHCs 33 are used by parking inspectors to receive information on parkers who have no tag 16a, defective tags 16a or tags 16a with no more parking credits. The HHCs 33 communicate with the server 30 and retrieve information about individual tags 16a upon request. In FIGS. 15 and 16, the parking inspector has clicked on the signal strength bar 36 with the highest intensity (=the car before he is standing). By clicking the “Get Data”-button the parking inspector retrieves information on the respective tag. If the bar is orange 36 (parking credits run out), the button “Fine” appears (see 15). By clicking on it the fining procedure is started.

Tags 16a can be purchased in parking shops, at tag vending machines (banknote-operated and with optional credit card function), partner shops (petrol stations etc.) and via the Internet.

Tags 16a are also available as prepaid tags with certain credits, mainly in shops. When used up, the tags 16a can be brought back to the issuing office or can be inserted at any vending machine (optional feature) to retrieve the deposit.

Resident customers may receive their parking tags via courier service or purchase them in parking shops.

In addition, customers can buy parking tags at vending machines around the clock. The vending machines are powered by solar panels. They accept banknotes with the values 20/50/100/500 DHS. The values of the tags 16a are adapted to the banknote values, so that the vending machines do not have to provide change. Neither does the vending machine print out a receipt. (A receipt can, however, be obtained on the Internet with the tag ID.) Thus the vending machines are very cost-effective. The tag values can for example be 100/200/500 DHS.

Part of the tag price covers a deposit for the tag; the rest is parking credits. With the tag, a plastic card with a magnetic stripe is issued—the Parking Card (see below).

Tags which are not used any more can be returned at parking shops or vending machines, the customer will get back the tag deposit and the remaining parking credit as long as the tag is in good condition for further usage. Vending machines identify tags via their bar codes.

Payment can also be done by “pay per space” parking machines, which are in use in many cities. Payment through “pay per space” does not require to buy a tag. Instead, motorists enter the number of their parking space (written onto the space) on the machine's display and pay the required amount. Thus, they do not have to go back to their vehicle and put a tag or ticket there. Parking inspectors only have to check directly at the machine which spaces have not been paid or have expired.

The parking management system according to the invention can be easily integrated into these systems if the machines are connected to a server providing an interface to the Server 32 of the CPMS 31. The machine server transfers all paid spaces 34 and their expiry time to the Server 32 of the CPMS 31 which decides when to report a parking offence.

This integration permits another dimension of comprehensive control allowing not only payment via tags 16a and mobile phones, but also via cash through pay-per-space machines.

Each tag 16a will be issued with a plastic parking card with a magnetic stripe (ISO format). The parking card holds the tag's bar code number (ID number) and a PIN code (which is stuck to the card, but can be removed). The parking cards can be used to charge the tags with parking credits at partner organisations like on ATMs, GSM provider terminals, or in banks adhering to standard data security criteria. In addition, customers can access and administer their card data on the Internet.

The parking card can also consist of a two-part sticker. One part, containing the PIN code, can be removed and put, for example, in the wallet of the customer.

A main part of the system is the backend system, which is connected to the servers on the site on the streets with Internet or WLAN connection. The backend system performs the following main functions:
Payment (Parking Transactions, Manage Parking Account)
Enforcement (Fine requests)

Each tag number and barcode number is stored in the central database in the backend system together with its credits (prepaid parking hours stored to this tag). The parking operator initially issues tags with the desired credits (e.g 10 EUR, 20 EUR etc.) at the central office and distributes the tags to the places where they are sold (e.g. vending machines or parking stores).

For each tag 16a, the backend system 31 manages a parking account, which is similar to a bank account. For each tag 16a the initially issued amount is stored in the database.

The Parking Account manages—similar to a bank account—the balances, payments and parking transactions of each motorist (tag 16a).

The Parking Account can be used both as a stored-value (e-purse) card and a classic charge card. In this concept the account will be configured as PRE-PAID account.

According to FIG. 13 each time a motorist passes the built-in magnetic field sensor of the parking space with his car, the tag number together with the unique parking space number is sent to the backend server 32. The server 32 checks if there are sufficient credits for starting a parking transaction for this parking spaces 34 (parking spaces in different zones of the city can cost different parking fees).

If there are not enough credits on the account of this RFID-tag 16a, the backend server 32 automatically issues a fine request to the parking inspectors via GPRS. The parking inspectors are equipped with GPRS enabled HHCs 33. The fine request provides information about the parking zone and the parking space. One of the parking inspectors in this zone confirms the fines request, goes to the parking space and issues the fine.

If there are enough credits on the tag account, the parking transaction will be started. The system on the parking space site switches on the red LED light in the hump 18.

When the motorist leaves the parking space 34, the RFID-tag 16a of the car is read again and parking data are sent again to the backend system 31 by the servers 30 on the site. The parking transaction will be ended and the amount, which was calculated on a minutes' basis for this zone will be withdrawn from the account of the motorist owning this RFID-tag 16a.

Each parking transaction will be ended by the backend system when:
Maximum parking limit is reached
The account balance is exhausted during the parking transaction
At the end of the day (according to the chargeable parking times (e.g. 20:00))

Each RFID-tag 16a is initially loaded with a desired amount (see above, e.g 10 or 20 EUR). Whenever the credits from an HF have been used up (parking transactions) the motorist has various options to reload his RFID-tag.
Internet
Parking Shops
ATM
Internet

The customer opens the website of the parking operator and browses to the “load tag” page. He enters his RFID-tag number and the desired amount he wishes to load on his tag.

The system then prompts the user to choose the desired payment options:
Creditcard
Bank Transfer

Additional common payment options can be integrated very easily. When the motorist confirms the payment, the amount is loaded to the HF tag.

Payment can be can be carried out in parking shops. The staff in the parking shop use the same website as mentioned above and enters the same information. The payment, however, has to be effected by credit card or cash.

Payment can also be effected through NFC (Near Field Communication) (e.g. in-built in mobile phones), Visa Electron, Mifare-based radio frequency, Legic, NFC etc. The reading device of such wireless money transfer systems is integrated in the signalling means.

Alternatively payment can be effected by means of an ATM. The motorist enters his bank card into an ATM and selects the “Tag Load Application”. He will be prompted to enter his HF tag number and the amount he wants to load onto the tag. The bank application withdraws the amount from the bank account of the customer and tells the backend system to load the specific amount onto the motorist's HF tag.

The Parking Account manages all transactions which are performed by the customers. The customer can check the following data via their personalised account overview on the webpage and print out receipts:
Transaction overview
Current account balance
Previous account statements

Parking inspectors work differently from other P&D systems. Thus parking enforcement is much easier with the HF tag system:
Parking offences can be detected in real time and are communicated to the nearest parking inspector's HHC.
Parking inspectors do not have to regularly check all vehicles of their competence zone, which otherwise consumes a lot of time. Thus fewer staff is required and efficiency is increased by up to 100 percent.
Parking without paying is made impossible; people who park and do not pay (who can make up to 30 percent of all parkers at peak times) are detected immediately. Thus revenues are increased.
Vehicles whose parking credits are about to expire can also be reported to the parking inspectors, who can check on their HHC where to go next. This saves valuable time.
Parkers who do not pay can be given warnings in the implementation phase, which increases the learning effect, before fines are issued.

The system provides the following data, which can be provided to a broad variety of interfaces:

Data on Individual parking Spaces
Occupancy status;
Parking time
Parking credits

Systemic Data
Average parking time of the zone
Average occupancy of the zone
Absolute occupancy of the zone
Statistical likelihood of getting a parking space at a certain time
When and where spaces are expected to become soon available (unless the motorist parking there exceeds the parking time limit)

Tag Data; Urban Management
Personalized data's of residential tags, user group tags (street workers, public official workers etc.)
Not personalized data's of mainstream short term parkers
All data is used to store, reconstruct and analyze the parking behavior to deliver comprehensible data's for the urban management.

It is possible to define several user groups with individual parking rights and rates, for example:
A) Residents
B) Non-residents
C) Disabled persons
D) Executive authorities, ambulance etc.
E) Taxis
F) Rental cars

Each user group can have its own parking rate, if required. Even different rates for different areas, for parking time windows etc., are possible. Thus parking as a residential in your home district during the night can be cheaper than parking in the city centre.

One of the major commercial advantages of the system is that the parking time begins immediately and automatically after the vehicle has been parked (the parking activation time—to ignore passing vehicles—becomes void after a certain time, which can be adjusted in the system), because parkers do not have to go to a parking meter (they also do not sit in the car and chat on the phone for a long time before they hang up and pay the parking fee via mobile phone), fill in a parking ticket etc., or wait in the car for some time for other reasons. Other parking payment systems “lose” this parking time. The decision of whether the parking time of a certain car is started is done by the system after comparing the data of the magnetic field sensors with the HF data, or by the customer pressing the activation button on his tag.

If the tag holder has registered for this option, he is charged immediately when the chargeable parking time begins (e.g. in the morning, when parking over night is free of charge). When the chargeable parking time stops, billing is stopped (e.g. 08:00-20:00).

In addition, parkers who do not pay are recorded and reported right after the parking time activation time. The start time (when the car entered the parking space) has been recorded by the system. Thus not only the parking fine but also the accurate parking time can be charged. This is a psychological advantage the system offers to get the thinking of some people “I don't pay for parking and risk getting a fine, in any case I saved the parking fee” out of their parking behaviour. This can be seen as an “educational” advantage, however it also raises the parking revenue and tells people that parking has to be payed anyway and any offence adds additional charges.

Regardless of that, due to administrative reasons, the standard tariff steps/time units can be used, i.e. steps of 1 hour. Thus parking spaces which have been occupied for e.g. 1.5 hours are immediately free for a new vehicle which triggers a new payment procedure.

The system according to the invention has thus a shorter payback period than P&D systems due to the following advantages:
Immediate start of parking time after the vehicle has parked
Highest efficiency on enforcement and incomparably raised enforcement revenues that lead on the long term to educated parking behaviours where most people will pay for parking—because not paying will, with utmost probability due to the high number of parking inspectors and the high precise alarm indication, cause a fine!
Incomparably lower operating costs (no coin exchange, no paper refill etc.)
Incomparably lower maintenance costs (no wear and tear parts, no paper dust etc.)
Less traffic caused by vehicles seeking a parking space through highly visible space indicators. In addition, vacant parking spaces are found and occupied faster.

Furthermore, the system according to the invention requires fewer vending machines than other P&D systems:
1.) Tags can be also bought at parking shops and partners stores, such as patrol stations and groceries.
2.) People who are residents of other districts/zones can use their normal tag with its prepaid function in zones where they are not allowed to park as residents.
3.) Tags 16a are reusable and can be recharged with parking credits again and again. Thus customers do not have to get a new tag each time they park their car.
4.) Tag deposits are quite cheap, thus also people who do not frequently park in zones where the system is installed will keep their tag in their car and do not have to get a new tag 16a each time they park their car there.
5.) There are various possibilities to reload a tag, e.g. directly at vending machines, from home via the Internet, or via existing infrastructure such as ATMs or ETISALAT, via mobile phone etc. Thus customers do not have to buy a new tag 16a just because their old one has no more credits.

Through the integrated parking guidance (single space indication+guidance signs), the system according to the invention leads vehicles directly to an available parking space. Thus, motorists do not have to move endlessly around the blocks searching for a space any more.

The system according to the invention may comprise interfaces to Urban Parking Guidance System with a Variable Message Sign System, which supports drivers to quickly find a free parking space and thus avoids unnecessary traffic. The system has the following features:
Accurate information for the urban traffic control centre and the City Council on how many vehicles park where and for how long.
Accurate information on the parking behaviour of residents.
Valuable information for street and traffic planning and urban transport scheduling.
Accurate information on available spaces in certain streets or areas.

Via IP and XML protocols the system according to the invention can provide 3rd party websites, navigation providers (map24.de; google maps etc.), information broadcasters etc. with detailed data on parking space availability in connected areas. This information can be accessed, for example, by persons with GSM navigation devices. The system according to the invention can be arranged to provide the following data:
Current zone occupancy
Average parking time
Current free/occupied spaces
Probability of finding a free space in a certain zone at a certain time (e.g. in zone XY, at 15:00, usually 5 spaces are free)
How many vehicles are likely to leave soon (because otherwise they would exceed the permitted parking time)

The above listed information can be made available to the local authorities, too.

Apart from a widely maintenance-free fee collection system, the system offers a great deal of added values:
1.) The city/municipal traffic department will be given precise statistical information: who is parking where and for how long.
2.) The system enables tracking and tracing cars. The city/municipal traffic department will be given a precise picture of parking behaviour and the flow of cars. This will be extremely helpful for road planning and city development.
3.) Parking offences (by cars that have no RFID-tag 16a, a broken tag, expired validity, not paid etc.) will be detected within seconds. Parking enforcement can be done automatically, or, in case the tag does not send its ID, a parking inspector will be directed to the respective parking space by his/her HHC 33.
4.) Parking humps 18 can also be installed in restricted areas, hence any offence will be detected and reported to parking enforcement or even to the police within seconds.
5.) Multiple payment possibilities: by credit card or mobile phone (for rental cars), by purchasing parking credits via a web interface etc.
6.) Parking tags 16a can be charged with parking credits via:
   Cash machine (ATM) by entering the last 8 figures of the tag number
   A web interface. This can be combined with a user-specific report on parking behaviour, parking credits spent, available credits etc.
   Mobile phone (text message to the parking tag account)
7.) CombiTag feature: People can park in their domestic district with their tag for an annual or monthly fee, and, if required and registered, also in other districts (for which the fee could be reduced, or a daily flat rate, which could also be paid by the person's employer etc.) The CombiTag can also be used by companies who pay their parking fees once a month via transfer slip or direct withdrawal authorization.
8.) Car holders who have registered for this function and thus obtained the required user rights can trace their car's location by mobile phone or on the Internet (where did I park my car last night, where did my wife park it, where is my son currently parking . . . )
9.) When parking in big areas like airports or shopping centres, drivers can send a query by mobile phone where their car is parked (using a PIN for security reasons).
10.) Easy parking enforcement: an RFID-reader-handheld 16 can read the tag 16a and make a printout to be placed behind the windscreen wipers and transmit the data to the control centre.
11.) Easy and automatic control of the activities and positions of all parking inspectors.
12.) Special provisions for company cars, local authorities etc.
13.) The tags 16a can also be used for offstreet parking—to open barriers, for payment etc.
14.) Users can purchase parking credits via web access and credit card.
15.) Users will be able to track their parking fees via the Internet or mobile phone.
16.) Users will be able to “turn off” automatic parking billing in case they lend their car to somebody else, who then has to pay via his own account.
17.) Users will be able to set an “alarm message” appearing on their mobile phone or in their email-inbox once a preset amount of parking credits or parking time will have exceeded.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. A signalling means configured to indicate whether a parking place for a vehicle is available or occupied, wherein the signalling means comprises:
a housing; and
at least one LED arranged within said housing,
wherein the housing comprises a cover that is at least partially made of a light-permeable material configured to form at least one light-passage for light emitted by the at least one LED,
wherein an outer surface of the light passage is slanted towards a bottom portion of the housing, and
wherein the signalling means further comprises at least one convex-lens that is arranged between the at least one LED and the light passage of the housing.

2. A signalling means according to claim 1, wherein at least one deflecting prism is arranged inside the housing and between the at least one convex lens and the light passage, and the at least one deflecting prism is configured to deflect light generated by the at least one LED in the direction of oncoming vehicles.

3. A signalling means according to claim 1, wherein the housing comprises a cylindrical base portion that is covered by the cover and a ring shaped cover portion comprising a ring-shaped flange extending in a radial direction from the base portion.

4. A signalling means according to claim 1, wherein the signalling means comprises at least one earth-magnetic-field-sensor for detecting the presence of a parked vehicle in the single parking place, wherein the earth-magnetic-field-sensor is arranged within the housing.

5. A signalling means according to claim 4, wherein the signalling means comprises a control unit connected to the at least one earth-magnetic-field-sensor and to the at least one LED, wherein the control unit activates the at least one LED according to a signal generated by the earth-magnetic-field to indicate the status of availability of the respective parking place.

6. A signalling means according to claim 1, wherein the signalling means comprises an RFID-reader that is arranged within the housing.

7. A signalling means according to claim 1, wherein the signalling means comprises an adapter for mounting the signalling means onto a hump forming a cable duct, wherein the adapter comprises a recess configured to enable insertion of the housing, wherein the ring shaped flange and an inner edging of the recess adjoin to one another continuously and the adapter comprises an outwardly slanted edging area.

8. Signalling means according to claim 1, wherein the signalling means comprises a camera module configured to few take pictures of the parking place (34), wherein said camera module is located within the housing (2).

9. An automated parking guidance and management system, comprising:
a signalling means mounted at the front end of a parking place (34), where the parking place (34) has to be entered by a vehicle via the front end, the signalling means comprising:
a housing; and
at least one LED arranged within said housing,
wherein the housing comprises a cover that is at least partially made of a light-permeable material configured to form at least one light-passage for light emitted by the at least one LED,
wherein an outer surface of the light passage is slanted towards a bottom portion of the housing, and
wherein the signalling means further comprises at least one convex-lens that is arranged between the at least one LED and the light passage of the housing.

10. An automated parking guidance and management system according to claim 9, wherein the signalling means is mounted on a hump forming a cable duct for power supply lines for the signalling means, wherein the hump is mounted at the front end of the parking place for a vehicle and the vehicle has to drive over the hump for entering the parking place.

11. An automated parking guidance and management system according to claim 9, wherein:
an RFID-reader is located inside the signalling means, which RFID-reader is arranged to detect the presence of an RFID-tag within the area of the parking place, and
the system is arranged to check using identification information received from the RFID-tag whether the RFID-tag is valid and the owner is allowed to use the parking place.

12. A signalling means according to claim 1, wherein the light passage itself forms a deflecting prism for deflecting light generated by the at least one LED in the direction of oncoming vehicles.
